(19) United States
(12) Patent Application Publication
(10) Pub. No.: US 2016/0215088 A1
(43) Pub. Date: Jul. 28, 2016

(54) ALDEHYDE FREE THERMOSET BIORESINS AND BIOCOMPOSITES

(71) Applicant: THE GOVERNORS OF THE UNIVERSITY OF ALBERTA, Edmonton (CA)

(72) Inventors: Tolibjon OMONOV, Edmonton (CA); Jonathan CURTIS, Edmonton (CA)

(73) Assignee: THE GOVERNORS OF THE UNIVERSITY OF ALBERTA, Edmonton, AB (CA)

(21) Appl. No.: 14/442,458

(22) PCT Filed: Nov. 12, 2013
(86) PCT No.: PCT/CA2013/050864

§ 371 Date: May 13, 2015

Related U.S. Application Data
(60) Provisional application No. 61/727,357, filed on Nov. 16, 2012.

(51) Int. Cl. C08G 59/42; C08G 59/20; C08J 5/04

(52) U.S. Cl. CPC C08G 59/4207; C08J 5/045; C08G 59/4238; C08G 59/20; C08J 2363/00; C08J 2497/02

(57) ABSTRACT

Aldehyde-free bio-based resin and composite materials include flexible or rigid thermoset resins of epoxidized oils derived from unsaturated oils which are cured with crosslinking carboxylic acids, natural food acids, anhydrides and acid anhydrides, and may be combined with different lignocellulosic fibers, forestry products or waste, with up to 100% renewable content.

### FIELD OF THE INVENTION

The present invention relates to aldehyde-free bio-based resin and composite materials, particularly flexible or rigid thermoset resins of epoxidized oils derived from unsaturated oils, cured with crosslinking carboxylic acids, natural food acids, anhydrides and acid anhydrides, and combined with different lignocellulosic fibers, forestry products or waste, with up to 100% renewable content.

### BACKGROUND OF THE INVENTION

Petroleum derived materials are becoming less and less attractive due to the uncertainty of the future supplies of petroleum derived chemicals and environmental concerns. The manufacturers of plastic materials and composites, and researchers have turned their attentions to find alternative renewable resources. Biobased products, including bioresins and biocomposites made from annually grown renewable resources are becoming an increasingly attractive alternative to conventional petroleum based materials. Biobased plastic materials and composites are likely to be more biodegradable compared to the petroleum based counterparts. Although natural fiber based composites are typically not as strong as glass or carbon fiber based composites, biobased composites reinforced with these fibers can be engineered to achieve certain properties for specific applications. Also, biobased composites have the advantage of low weight and less abrasive behaviour of the biobased composites to production equipment (Mohanty A. K. et al eds: “Natural Fibers, Biopolymers, and Biocomposites”, CRC Press, Boca Raton, Fla., 2005).

Urea-formaldehyde (UF) and phenol-formaldehyde (PF) resins which are toxic, petroleum-based adhesives have been used as wood adhesives for many years. The level of formaldehyde gas emission is regulated by the law. Since 2008, the International and European Organization for Standardization (ISO and CEN, respectively) require that formaldehyde emissions of wood-based panels and composites to be lower than 0.1 ppm, and in some European countries limited to ≦0.124 mg/m³. Formaldehyde emission limits in some European countries are 6.5 mg/100 g for particleboard, and 7 mg/100 g for fiberboard. The Japanese standard (JIS) for formaldehyde emissions is even lower and limited up to 0.3 mg/L.

The limit of aldehyde emissions from wood particle and fiberboards in US and Canada are regulated. Use of phenol-formaldehyde resin to make composite wood panels sold in California has been changed to meet stringent airborne emissions standards, forcing manufacturers to switch to new resin compositions. In addition, the International Agency for Research on Cancer (has reclassified formaldehyde from “probably carcinogenic to humans” to “carcinogenic to humans”.

Therefore, uncertainty in future supplies of petroleum derived chemicals and polymers, environmental concerns, and stringent regulations on toxic emissions from building materials have led the researchers and companies to seek alternative sources of adhesives from renewable resources, with similar properties at reasonable costs. There have been multiple attempts to make formaldehyde-free boards and composites.

Various processes of making composite materials exist in the prior art, with reduced or no aldehyde emission using diverse bio- or petroleum-based chemicals or combination of these chemicals. Structural composites with a high content of renewable material were produced from flax fibres (fiber content between 30-70 wt %) and an acrylated epoxidized soybean oil resin (AESO), by spray impregnation followed by compression moulding at elevated temperature (Akesson D. et al., JAPS (2009), 114, 2502). A 1,1-di-(tert-butylperoxy)-cyclohexane was used as a curing/oxidizing initiator of AESO. US Patent Application 2005/0070635A1 entitled “Wood composites bonded with protein-modified urea-formaldehyde resin adhesive” attempts to reduce emission levels with the use of an adhesive binder composition based on urea-formaldehyde resin modified with soy protein (soy protein 0.1-10% to resin solid) acting as binding enhancing component for preparing wood particle composites. Internal bond strength has shown more than 20% improvement with modified adhesive binder, but no improvements in aldehyde emissions were reported.

Vacuum-assisted resin transfer molding (VARTM) have been used to make composite panels using acrylated epoxidized soybean oil (AESO) and natural fiber mats made of flax, cellulose, pulp and hemp (Composites Science and Technology (2004), 64, 1135; Composite Structures (2006), 74, 379). The mixture of an AESO precursor with styrene was cured using cumyl peroxide as initiator and cobalt naphthenate as catalyst in preparing resin materials. This combination of resin and cellulose fibers, in the form of paper sheets made from recycled cardboard boxes have shown the required stiffness and the strength required for roof construction, and were successfully used to manufacture composite structures. These natural composites were found to have mechanical strength and properties suitable for applications in housing construction materials, furniture and automotive parts.

There have been fewer attempts to prepare biobased composites using modified vegetable oil precursors as adhesive binders of lignocellulosic materials. The properties of hemp fiber (0-65%) based composites using epoxidized linseed oil cured with methyl tetrahydrophthalic anhydride as a hardener and 2-methylimidazole as the catalyst have been investigated (SAPS (2006), 101, 4037). Despite a negative effect of hemp fibers on resin thermo-mechanical properties, a reinforcement effect is observed at high temperatures. The decrease of the mechanical properties of the resin was attributed to the absorption of anhydrides by hemp fibers, while no reaction of anhydrides with hydroxyl groups of fibers were noticed by FTIR.

Biobased “green” composites have been developed (Liu Z., et al., J. Agric. Food Chem. (2006), 54, 2134) from epoxidized soybean oil, and 1,1,1-tris(p-hydroxyphenyl)ethane triglycidyl ether (THPEGE) as a co-matrix resin, along with flax fiber, using a compression molding method. It was claimed that the resulting composites had sufficient mechanical properties to be used in a wide variety of areas, such as agricultural equipment, civil engineering, and the automotive and construction industries.

It is also known to produce inter-fiber bonding adhesives using protein or lignin based components to make formaldehyde-free particle- or fiber-boards (U.S. Pat. No. 7,736,559 B2 and 7,785,440 B2). These proteins (mainly soy protein) have been cured using polymeric quaternary amine cure accelerant, or imid, amid, imine or nitrogen containing heterocyclic functional groups that can react with at least one functional group of the soy protein. U.S. Pat. No. 7,416,598 B2 describes adhesive compositions similar to conventional UF and PF resins, including proteins and modifying ingredients consisting of carboxyl-containing, epoxy and aldehyde containing compounds. It was claimed that such adhesives can provide fast curing and strong bonding characteristics.

The majority of the resins in biocomposites are limited to soybean and linseed oil derivatives, and mostly acrylates. An acrylation process of the vegetable oil based epoxides will directly increase the production cost of the final products. Moreover, in all cases the curing of these vegetable oil based resin precursors were carried out using petroleum based curing agents, catalysts and initiators, or combination of all of these products.

### SUMMARY OF THE INVENTION

The present invention relates to a process of making bioresin and biocomposites with up to 100% renewable content, or without the use of any petroleum-based material, using an epoxidized oil derived from any unsaturated oil such as vegetable, nut, algal, animal or tall oil or fat and their derivatives, along with natural food acids, biobased carboxylic diacids, and acid anhydrides, that in combination can be used as thermoset bioresins. Such resins may be applied as bonding adhesives to make lignocellulosic fiber- or particle-boards and panels.

In one aspect, the invention may comprise a method for preparation of a thermoset resin prepolymer comprising the step of reacting an epoxidized oil or fat derived from an unsaturated oil or fat, or their derivatives, with a crosslinking carboxylic acid or an anhydride to prepare a prepolymer. The prepolymer may be cured and molded at elevated temperatures to make neat thermoset resins. The prepolymer may be mixed with or applied to reinforcing fibers and curing the material to form a thermoset biocomposite material.

In one embodiment, the epoxidized oil and the carboxylic acid or anhydride are derived from entirely renewable sources. The carboxylic acid may comprise a natural food acid, such as citric, malic, tartaric, acetic, oxalic, tannic, caffeotannic, benzoic, butyric, or lactic acid.

In one embodiment, the epoxidized oil comprises a vegetable oil comprising mono- and polyunsaturated fatty acids, such as linseed, canola, soybean, or camelina oil.

In another aspect, the invention comprises a thermoset resin prepolymer comprising an epoxidized vegetable oil with a compound containing two or more carboxylic acid groups or one or more anhydride groups.

In yet another aspect, the invention comprises a biocomposite material comprising cured prepolymer and a reinforcing fiber.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIG. 1. Temperature dependence of storage modulus and loss factor (measured by DMA) of bioresins of ECO, ECamO, ESO and ELO cured with CA, demonstrating the influence of epoxy precursor type to the mechanical performance of resin.

FIG. 2. Temperature dependence of storage modulus and loss factor (measured by DMA) of ECO bioresins cured with TMA, PA and CA, demonstrating influence of the type of different co-curing agents to the mechanical performance of the resin.

FIG. 3. The viscoelastic properties of the ECO based resin at equimolar ratio of components cured at 155° C., as measured by rheometer. Vertical dashed line highlights is the gelation time of the system. Black area corresponds to the pre-polymer preparation time and grey area is the equilibration time in rheometer.

FIG. 4. Storage modulus of ECO and PA based resin at equimolar composition of components at different temperatures, as measured by rheometer. Black area corresponds to the pre-polymer preparation time and grey area is the equilibration time in rheometer.

FIG. 5. Storage modulus of ECO and PA based resin with different molar ratio of components and cured at 155° C., as measured by rheometer. The ratios of components are indicated near respective curves.

FIG. 6. Temperature dependence of storage modulus and loss factor (measured by DMA) of bioresins of ECO cured with PA at a temperature of 155° C. and at different ratios of components.

### DETAILED DESCRIPTION OF THE INVENTION

The present invention relates to biobased thermoset resins and biocomposites. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

In general terms, the biobased resins claimed herein are formed from epoxidized unsaturated oils, which are cured with crosslinking carboxylic acids, such as organic carboxylic acids or natural food acids, or anhydrides such as aromatic or aliphatic anhydrides. Preferably, the constituent materials are derived from entirely renewable sources. As used herein, a “renewable source” means a natural source which can replenish with the passage of time, either by biological reproduction or other naturally recurring processes.

In one embodiment, the unsaturated oil comprises fatty acids that are esterified to other moieties, such as fatty acids esterified to glycerol that makes up mono-, di- or triacylglyceride oils. Preferably, the oil is comprised substantially of triacylglyceraols (TAGs) which contains several double bonds. The epoxidized unsaturated oils used in this invention can be fully or partially epoxidized oils, with at least one epoxy group, but preferably with two or more epoxy groups per TAG molecule. Epoxidized oil TAGs may still contain one or more unsaturated fatty acids, esters, saturated fatty acid, or other reactive groups, such acrylic groups, and the like, that can be incorporated into crosslinking reactions with curing agents during further curing processes.

The unsaturated oil may comprise any unsaturated oil such as vegetable, nut, algal, animal or tall oil or fat and their derivatives. In one embodiment, the unsaturated oil comprises a vegetable oil. Epoxidized vegetable oils used in this invention may be commercially available, or prepared according to a procedure described in US Patent Application Publication 2013/0274494 A1, the entire contents of which are incorporated herein (where permitted), using an oxidation procedure with formic acid and hydrogen peroxide. Suitable oils for making epoxidized derivatives can be any type of unsaturated vegetable oils, preferably with two or more double bonds per oil TAG, which double bonds are readily available for oxidation. These oils may comprise, but are not limited to, canola (rapeseed) oils, linseed oils, soybean oils, camelina oils, sunflower oils, safflower oils, coconut oils, cottonseed oils, palm oils or palm olein, castor oils and the like, or mixtures thereof.

In one embodiment, the epoxidized vegetable oils may comprise epoxidized canola oil (ECO), epoxidized linseed oil (ELO), epoxidized soybean oil (ESO) or epoxidized camelina oil (ECamO), or mixtures thereof. In the thermoset bioresin or biocomposites formulations according to the present invention, mixtures of different epoxidized oils may be used, resulting in varying mechanical performance of the resulting resins or biocomposites. In canola oil, most of the fatty acid chains contain only one double bond (monounsaturated). However, canola oil also comprises a smaller number of fatty acid chains are di-unsaturated or polyunsaturated (3 or more double bonds). Overall, since there are 3 fatty acid chains per TAG molecule that makes up the oil, each canola TAG molecule contains an average of between 3 and 4 double bonds, averaging about 3.9 depending on the cultivar. Some other oils such as linseed oil, contain a much higher proportion of double bonds. Some or all of the double bonds may be epoxidized in the oil used in the present invention.

Molecular weight of the epoxidized oils may vary from 500 to 10000 g/mol, but preferably in the range of 500-2000 g/mol, and more preferably in the range of 500-1200 g/mol. The number of epoxy functional groups of the epoxidized oils can be varied from 1 up to 9 groups per epoxidized TAG molecule, but preferably, in the range of 2-9 epoxy groups per epoxidized TAGs, more preferably 3-9 epoxy groups per epoxidized TAGs.

The epoxidized vegetable oils may be cured with crosslinking carboxylic acids. Because the functional acid groups crosslink the epoxidized fatty acid chains, it is believed that crosslinking carboxylic acids should comprise two or more functional acid groups. These carboxylic acids may comprise, but are not limited to, aliphatic or aromatic carboxylic acids, such as oxalic, malonic, succinic, glutaric, adipic, pimelic, suberic, azelaic, sebacic acids, phthalic, isophthalic, teraphthalic acids and the like, or mixtures thereof.

The carboxylic acids may preferably comprise natural food acids to form a thermoset bio resin with 100% renewable content. “Natural food acids” are carboxylic acids found in natural food products, which may include, without limitation, citric, malic, tartaric, acetic, oxalic, tannic, caffeotannic, benzoic, butyric, lactic acid and the like, or mixtures thereof. Preferably, the natural food acid comprises two or more functional acid groups. These natural food acids may also comprise different reactive functionalities such as hydroxyl groups, together with the acid functionalities, that can be incorporated into crosslinking reactions with the epoxidized oil during the curing processes.

The epoxidized vegetable oils may also be cured using crosslinking aromatic or aliphatic anhydrides (both symmetrical and non-symmetrical), preferably di-anhydrides, or aromatic or aliphatic anhydrides with multifunctional acid and anhydride groups, or with the mixture of aromatic or aliphatic anhydrides with similar or multiple reactive functionalities. These additional functionalities of anhydrides or acid anhydrides may include one or more double bonds, or other reactive moieties such as esters, ethers, amines, imines, amides, ureas, carbonates, mixtures thereof and the like, that can be incorporated into crosslinking reactions with epoxides during curing processes. These anhydrides or acid anhydrides can be particularly, but are not limited to, maleic, phthalic, isophthalic, tetraphthtalic, pyromellitic, succinic, trimellitic anhydrides and the like, and mixtures thereof.

The curing reaction of the epoxidized vegetable oils with acids and acid anhydrides comprise crosslinking reactions of the epoxides with acids or acid anhydrides to form carboxylic esters and hydroxy functionalities. The crosslinking density of these thermoset resins depends, in part, on the number of epoxy, acid or anhydride functionalities of reactive components. In one embodiment, at least a stoichiometric ratio of 1:1 of epoxy groups of epoxidized vegetable oils and acid/anhydride reactive sequences of the curing agents is preferred, and more preferably slightly higher concentration (up to about 20%) of curing agents may be used.

In one embodiment, neat thermoset bioresins can be prepared with or without a suitable solvent. If a solvent is used, the curing agents/reactants are dissolved in the solvent and an epoxidized vegetable oil is added to the solution. This mixture is blended, preferably at a elevated temperature of up to 50° C., until a homogenous pre-polymer solution is obtained. This mixture is then transferred into an apparatus to remove the solvent, such as a rotary evaporator with the batch temperature of up to 50° C. After solvent removal, the prepolymer is transferred into a suitable mold for further curing.

Suitable solvents include polar aprotic or protic solvents, such as acetone, ethyl acetate, dichloromethane, an alkyl alcohol such as methanol or ethanol, or the like. Generally, polar solvents are those with a dielectric constant of greater than about 5.0.

In one embodiment, the prepolymers of epoxidized oils may be cured in 3 stages:
Stage 1: prepolymer treatment, typically at about 60-70° C., is intended to remove a substantial portion of the solvent from prepolymer network, thus to avoid the formation of blisters, bubbles or other defects. At this stage, the prepolymer is still in a liquid state which is suitable for the use in diverse applications. Depending on the epoxy precursor functionality and the type of the curing agent, this initial step can take from few minutes up to several hours.
Stage 2: At a higher temperature, typically at about 90-100° C., the mixture starts to get into an initial curing phase and the liquid prepolymer starts to form a gel, and then begin to form a solid hard or flexible resin state. Depending on the epoxy precursor functionality and the type and number of functionalities of the curing agents or mixture of curing agents this step also can take from few minutes up to several hours.
Stage 3: This is the final stage of curing of the thermoset resin, typically at about 120-200° C. The resin will be cured to a solid state, and the final mechanical and physical properties of the cured resin will be achieved. Depending on the epoxy precursor, type or functionalities of curing agents and the physical dimensions of resin or molded item, this step may have very broad range of curing temperature and much extended curing periods.

The thermoset resin prepolymers may be applied to or mixed with any reinforcing fiber to form a biocomposite material. Suitable fibers including natural cellulosic or lignocellulosic fibers or fiber-mats, such as forestry materials and wastes including hardwood and softwood chips, hemp, straw, triticale, soybean protein fibers, or other agricultural plant fibers, crystalline cellulose, synthetic fibers such as carbon, glass, or aramid (Kevlar™), or non-organic fibers such as basalt fibers. The fiber may comprise cellulosic materials such as crystalline cellulose (micro- or nano-crystalline cellulose), which may not be in “fiber” form, but may still be suitable to form a biocomposite. The fibers may be in the form of solution or emulsion. After application of the prepolymers to the surface of the fibers, the “wetted” fibers may be stored as a prepreg material, at room temperatures from several minutes up to few days prior to manufacturing the biocomposites, or to produce molded parts using elevated heat and the pressure. Storage of lignocellulosic materials with sprayed prepolymers or subsequent heating of these products to form biocomposites will evaporate any remaining solvent.

In one embodiment, the fibers comprise lignocellulosic fibers which may have been preheated to about 70° C. or higher. A prepolymer dissolved in a suitable solvent may then be applied or mixed with the fibers, such as by spraying the fibers. The fibers are thus wetted with the prepolymer, and then later cured to form the biocomposite.

The curing conditions may be varied according to the melting, decomposition or degradation temperatures of the components used. For example, biocomposites made with citric acid may be cured at about 170° C., while those made with azelaic acid may be cured at about 200° C. These temperatures are above the melting point of the prepolymer, but below the decomposition temperature of the natural food acid curing agent. Curing may be combined with molding under pressure. After an initial curing period, the biocomposite may then be subject to a post-curing treatment to complete the curing process, and allow for more complete evaporation of any solvent.

Suitable solvents include acetone or an alcohol which can efficiently dissolve at least one component of the resin. However, any solvent which can efficiently dissolve at least one of the components of resin and to form a solution, suspension or emulsion of the other component, can be used. The function of these solvents is at least to ease-off the formation of the prepolymers at low temperatures, which can be recovered up to 100% prior to neat resin formation; and/or to control the viscosity of prepolymer during composite preparation, for easy dispensing using conventional dispensing equipment, such as to lower the viscosity in order to enable the use of spraying equipment.

Biocomposite thermoset objects may be formed using known techniques to form fiber-reinforced plastic materials, such as compression molding, spin casting, extrusion molding or reactive injection molding.

Exemplary embodiments of the present invention are described in the following Examples, which are set forth to aid in the understanding of the invention, and should not be construed to limit in any way the scope of the invention as defined in the claims which follow thereafter. As will be apparent to those skilled in the art, various modifications, adaptations and variations of the specific disclosure herein can be made without departing from the scope of the invention claimed herein.

### EXAMPLES

### Example 1

### Epoxidation of Vegetable Oil

Into a 12 L spherical, jacketed glass reactor, equipped with a bottom drain, and attached to a recirculating liquid cooler, about 2000 g of vegetable oil was loaded at room temperature, and mixed with overhead mechanical stirrer ˜300 rpm. Subsequently, hydrogen peroxide (room temperature, 35%) is added through a funnel. Once the homogeneity of the oil with H₂O₂ is achieved, formic acid (room temperature, 85%) was added dropwise to the vessel, at a rate of 10-20 g/min. After 1 hour of the mixing, the temperature of the chiller was slowly and continuously increased (at a rate of 10° C./hour) until the temperature reached 50° C. The epoxidation reaction was allowed to proceed for 20 hours at 50±5° C. under continuous stirring. Completeness of the epoxidation reaction was verified by LC-MS analysis. In all epoxidation processes of different oils, about 0.25 mol of formic acid and 1.4 mol of H₂O₂ are used for every mole of C═C double bonds in the vegetable oil. After the epoxidation process, the acidic aqueous phase was drained out and the organic phase was dissolved with ethyl acetate in about 1.0:1.0 w/w ratio. The organic phase was then washed with water, 0.6 M solution of sodium hydroxide (NaOH) and brine to neutralize acid, and dried with Na₂SO₄, filtered, and concentrated with a rotary evaporator. The epoxidized vegetable oil is a clear light yellow liquid, with traces of epoxy crystals at room temperature, depending on epoxy functionality.

### Example 2

### 100% Biobased Resin of Epoxidized Linseed Oil (ELO) Cured with Citric Acid (CA)

A desired amount of CA was dissolved in 100 g of solvent (acetone) in a glass flask at a temperature of 50° C. and a desired amount of ELO was added into this mixture. The mixture was thoroughly mixed by a mechanical mixer until a homogeneous mass was obtained. The ratio of ELO/CA was varied in ratios between 1.0:1.0 (0.05 mol:0.05 mol) and 1.0:2.0 mol (0.05 mol:0.10 mol). Stoichiometric ratio of 1:1 of the epoxy and acid groups is generally preferred, and up to 20% more added acid functionality is even more preferred, which increases cure rates and the thermoset polymer may display better mechanical performance. Prepolymer formation and curing of these mixtures were carried out according to the EXAMPLE 3. The final product is thermoset polymer with 100% biobased, renewable content, which can be used in diverse applications.

### Example 3

### Prepolymer Formation and Curing of Bioresins of Epoxidized Oils

Formation of prepolymers of vegetable oil epoxides with respective curing agents were carried out at 50° C., for about 30 min under continuous mixing, while completely removing the solvent under vacuum with up to 20 mbar. Then, formed prepolymer was transferred into a preheated (60-65° C.) PTFE mold (100×100×6 mm) for further curing. The curing of these neat bioresins were carried out in three steps, at 60-65° C. for 2 hours, at 90-100° C. for 2 hours and at 120-200° C. for 2 hours, as described previously, followed by slow cooling at a rate of 1.0-1.5° C./min.

### Example 4

### 100% Biobased Resin of ELO Cured with Malic Acid (MA)

A desired amount of MA was dissolved in 100 g of solvent in a glass flask at a temperature of 50° C. and the desired amount of ELO was added into this mixture. The mixture was thoroughly mixed by a mechanical mixer until a homogeneous mass is obtained. The molar ratio of ELO/MA was varied in ratios between 1.0:2.0 (0.05 mol 0.1 mol) and 1.0:3.0 mol (0.05 mol 0.15 mol). However, a stoichiometric ratio of 1:1 of the epoxy and acid groups is preferred. Formations of prepolymers of these mixtures were carried out according to EXAMPLE 3. The final product is thermoset polymer with 100% biobased, renewable content.

### Example 5

### 100% Biobased Resin of Epoxidized Canola Oil (ECO) Cured with CA

A desired amount of CA was dissolved in 100 g of solvent (acetone) in a glass flask at a temperature of 50° C. and the desired amount of ECO was added into this mixture. The mixture was thoroughly mixed by a mechanical mixer until a homogeneous mass was obtained. The ratio of ECO/CA was varied in ratios between 1.0:1.0 (0.05 mol:0.05 mol) until 1.0:2.0 mol (0.05 mol:0.10 mol). However, a stoichiometric ratio of 1:1 (1.0 mol:1.3 mol) of the epoxy/acid groups is preferred. At higher concentrations of the CA (more than 1:1 stoichiometric ratios), precipitation of citric acid particles was observed. Formations of prepolymers of these mixtures were carried out according to the EXAMPLE 3. The final product is thermoset polymer with 100% biobased, renewable content.

### Example 6

### 100% Biobased Resin of Epoxidized Soybean Oil (ESO) Cured with CA

A desired amount of CA was dissolved in 100 g of solvent (acetone) in a glass flask at a temperature of 50° C. and a desired amount of ESO was added into this mixture. The mixture was then thoroughly mixed by a mechanical mixer until a homogeneous mass was obtained. The ratio of ESO/CA was varied in ratios between 1.0:1.0 (0.05 mol:0.05 mol) until 1.0:2.0 mol (0.05 mol:0.10 mol). However, a stoichiometric ratio of 1:1 (1.0 mol:1.5 mol) of the epoxy/acid groups is preferred. At higher concentrations of CA (more than 1:1 stoichiometric ratios), precipitation of citric acid particles was observed. Formations of prepolymers of these mixtures were carried out according to EXAMPLE 3. The final product is thermoset polymer with 100% biobased, renewable content.

### Example 7

### 100% Biobased Resin of Epoxidized Camelina Oil (ECamO) Cured with CA

A desired amount of CA was dissolved in 100 g of solvent in a glass flask at a temperature of 50° C. and a desired amount of ECamO was added into this mixture. The mixture was thoroughly mixed by mechanical mixer until homogeneous mass was obtained. The ratio of ECamO/CA was 1.0:2.0 mol (0.05 mol:0.10 mol). Formations of prepolymers of these mixtures were carried out according to EXAMPLE 3. The final product is thermoset polymer with 100% biobased, renewable content.

### Example 8

### 100% Biobased Resin of ECO Cured with Azelaic Acid (AA)

A desired amount of AA was dissolved in 100 g of solvent in a glass flask at a temperature of 50° C. and desired amount of ECO was added into this mixture. The mixture was thoroughly mixed by a mechanical mixer until a homogeneous mass was obtained. The ratio of ECO/AA was 1.0:2.0 mol (0.05 mol:0.10 mol) in this experiment. Formations of prepolymers of these mixtures were carried out according to EXAMPLE 3. The final product is thermoset polymer with 100% biobased, renewable content.

### Example 9

### Biobased Resin of ECO Cured with Trimellitic Anhydride (TMA)

A desired amount of TMA was dissolved in 100 g of acetone in a glass flask at a temperature of 50° C. and the desired amount of ECO was added into this mixture. The mixture was thoroughly mixed by mechanical mixer until homogeneous mass was obtained. The ratio of ECO/TMA was varied in ratios between 1.0:1.0 (0.05 mol:0.05 mol) to 1.0:10 mol (0.05 mol:0.10 mol) in our experiments. Formations of prepolymers of these mixtures were carried out according to EXAMPLE 3. The final product is thermoset polymer with biobased, renewable content in the range of 71-83 wt %.

### Example 10

### Biobased Resin of ECO Cured with Phthalic Anhydride (PA)

A desired amount of PA was dissolved in 100 g of acetone in glass flask at a temperature of 50° C. and desired amount of ECO was added into this mixture. The mixture was thoroughly mixed by a mechanical mixer until a homogeneous mass was obtained. The ratio of ECO/PA was varied in ratios between 1.0:1.0 (0.05 mol:0.05 mol) to 1.0:2.0 mol (0.05 mol:0.10 mol) in our experiments. Formations of prepolymers of these mixtures and curing were carried out according to EXAMPLE 3. The final product is thermoset polymer with biobased, renewable content in the range of 76-87 wt %.

### Example 11

### Dynamic Mechanical Properties of Bioresins

The dynamic mechanical properties of selected bioresins were determined using DMA Q800 (TA Instruments) dynamic mechanical analyzer, in single cantilever clamp mode at a frequency of 1 Hz, in the temperature range from −100° C. up to 100° C., with the heating ramp of 2° C./min. Glass transition temperatures highlighted in TABLE 1 refers to the maximum of loss factor (tan delta). Note that the molar ratio of components refers to about the stoichiometric ratio of epoxide to acids or acid anhydride reactive moieties of the resin components.

TABLE 1
Glass transition temperatures of the bioresins
with 100% biobased, renewable content.

| | Molar ratio of | T_{g} |
|---|---|---|
| Entry | entry components | [° C., DMA) |
| ELO/CA | 1.0:2.0 | 42.4 |
| ELO/MA | 1.0:3.0 | 18.4 |
| ECO/CA | 1.0:1.3 | 24.8 |
| ESO/CA | 1.0:1.5 | 25.9 |
| ECamO/CA | 1.0:2.0 | 22.4 |
| ECO/TMA | 1.0:2.0 | 53.5 |

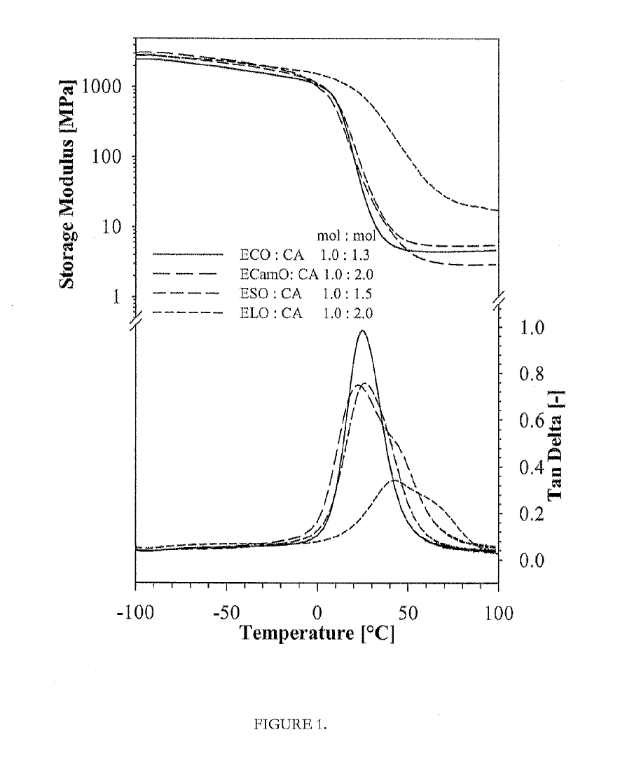

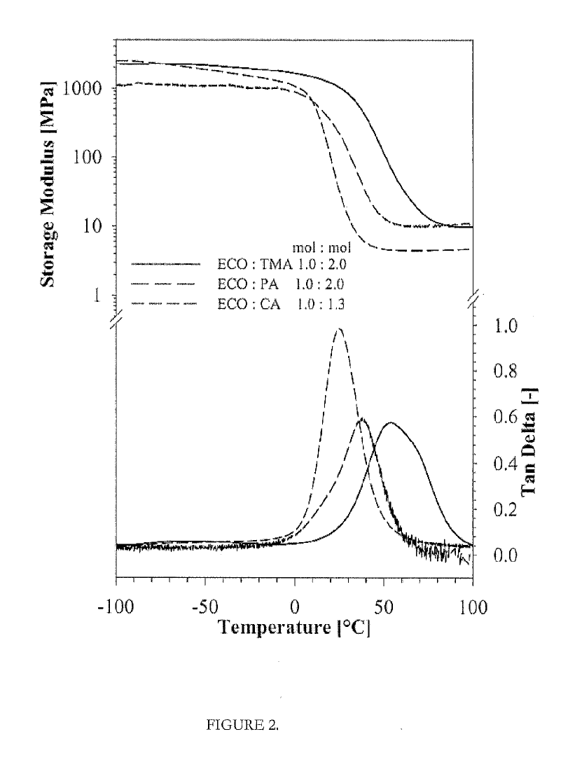

As an example, FIG. 1 shows the temperature dependence of storage modulus and loss factor of 100% bioresins of ECO, ECamO, ESO and ELO cured with CA, demonstrating the influence of different epoxy precursor type to the mechanical performance of the resins. FIG. 2 illustrates the temperature dependence of storage modulus and loss factor of ECO based bioresins cured with TMA, PA and CA, demonstrating the influence of the type of different co-curing agents to the mechanical performance of the resins.

Narrow width and higher intensity of tan delta peak is observed for the ECO/CA resin, indicating more homogenous thermoset polymer network compared to other resins. This was expected from the structure of the ECO, that consist of mainly epoxidized TAG with three epoxy groups, resulted from the FA profile (mainly oleic acid) of canola oil. The tan delta peak ESO, ECamO and ELO based resins are somewhat smaller, which indicates the increased crosslinking density of the thermoset resin networks. An increased amount of crosslinking density limits the chain mobility, in turn, led to the decrease in intensity of the peak. Moreover, the appearance of the second peak in tan delta curves as a shoulder (more pronounced in ECamO and ELO based resins) is due to the increased epoxy functionality of the epoxidized oils, which also lead to higher values of the glass transition temperature.

### Example 12

### Biobased Resin of ECO Cured with PA, without Use of Solvent

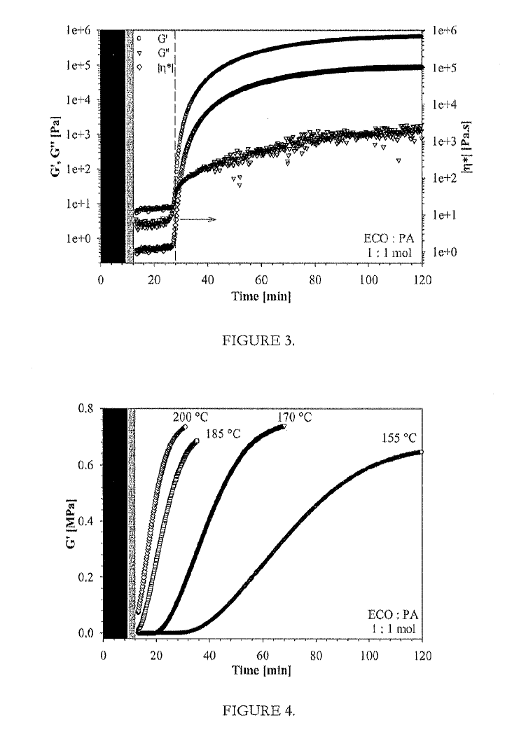

ECO based thermoset resins were prepared using phthalic anhydride as co-curing agent, without use of solvent. PA was mixed with ECO at different molar ratios of components, at room temperature. Then, the temperature of mixture was increased up to curing temperatures under continuous mixing, to prepare a prepolymer of the ECO with PA. Prepolymer preparation was carried out in 8-12 min, depending on the curing temperature and the concentration of anhydride. The prepolymers were transferred into the Teflon mold (with the size of 100×100Δ6 mm3) with respective preheated temperature, for further curing. Three groups of samples were prepared differing with molar ratio of components 1.0:1.0, 1.0:1.5 and 1.0:2.0; and at four different curing temperatures of 155, 170, 185 and 200° C.; each above the melting point of phthalic anhydride. Curing was allowed for about 6 hours at the selected temperature, followed by slow cooling at a rates of 1.0-1.5° C./min. The final product was a thermoset polymer with biobased content of between 76-87 wt %. Gelation time of ECO/PA biobased resins cured at different temperatures, as determined from rheological experiments are given in TABLE 2, below. As an example, FIG. 3 represents the viscoelastic properties of the ECO based resin at equimolar ratio of components.

TABLE 2
Gelation time of ECO/PA based bioresins cured at different temperatures
and at different ratios of components, as determined from rheological
experiments. The data in filled areas are extrapolated values from linear
trend, due to the fastest curing at higher temperatures.

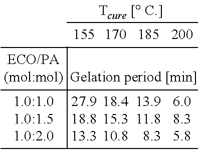

### Example 13

### Viscoelastic and Dynamic Mechanical Properties of Bioresins of the ECO Cured with PA

Depending on the curing conditions and PA content, clear and transparent resins were formed from rubber-like flexible thermoset (at low temperatures and low PA content) to almost rigid, semi-flexible plastic (at high temperature of curing and high PA content). The color of the resins cured at low temperature was light yellow, while the thermoset resins cured at high temperatures had yellow-light brown colors, TABLE 3 highlights the glass transition temperatures of the biobased resins at different ratios of components, and cured at different temperatures.

TABLE 3
Glass transition temperatures of the ECO/PA based resins
at different ratios of components and cured at different
temperatures as determined from DMA. The uncertainties
are standard deviations of at least duplicates.

T_{cure} [° C.]

| | | | | |
|---|---|---|---|---|
| ECO/PA | 155 | 170 | 185 | 200 |

| | |
|---|---|
| (mol:mol) | T_{g} [° C., DMA] |

| | | | | |
|---|---|---|---|---|
| 1.0:1.0 | −3.6 ± 1.2 | −4.4 ± 1.4 | −4.4 ± 0.3 | −3.3 ± 0.6 |
| 1.0:1.5 | 13.1 ± 0.4 | 13.5 ± 0.9 | 15.5 ± 1.1 | 17.7 ± 0.3 |
| 1.0:2.0 | 37.8 ± 0.6 | 40.4 ± 0.6 | 39.0 ± 0.1 | 39.1 ± 0.7 |

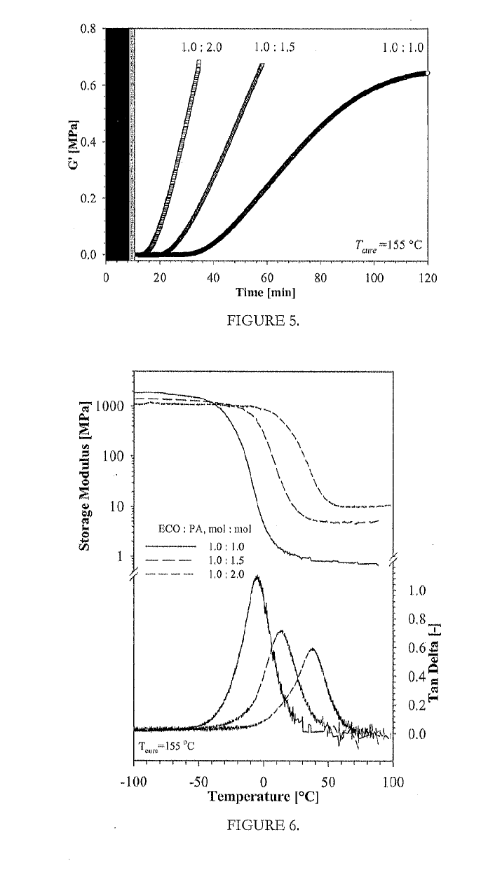

The thermo-mechanical properties of the final resins are found to be less dependent on the curing temperature of the resin (TABLE 3, FIG. 6), while elevated temperatures significantly accelerated the curing rates of the resins (FIG. 4). On the other hand, an increase in the amount of PA significantly affects the reaction rate (FIG. 5) as well as the thermal-mechanical properties of the final product (TABLE 3, FIG. 6). Thus, a selective combination of temperature of curing and the amount of co-curing agent in curing of epoxidized materials play a key role in creating the thermoset resin with pre-designed thermo-mechanical properties.

### Example 14

### Biobased Binding Adhesive Preparation for Composite Applications

A binding adhesive composition of prepolymer was prepared. In this regard, 19.2 g of CA (0.10 mol) is dissolved in 100 g of acetone at a temperature of about 50° C., and subsequently 47.5 g (0.05 mol) of ELO is added to this solution. The mixture was mixed at 50° C. for about 30 min to form a prepolymer of ELO with CA. Viscosity of the prepolymer was adjusted by removing the excess of solvent, according to requirements of the dispensing equipment.

A binding adhesive composition is prepared using ELO as epoxy precursor and TMA as a co-curing agent. In this regard, 19.2 g of TMA (0.10 mol) is dissolved in 100 g of acetone at a temperature of about 50° C., and subsequently 47.5 g of ELO (0.05 mol) is added to this solution. The mixture was mixed at 50° C. for about 30 min to form a prepolymer of ELO with TMA. Viscosity of the prepolymer was adjusted by removing the excess solvent, according to requirements of the dispensing equipment.

A binding adhesive composition is prepared using ELO as epoxy precursor and PA as co-curing agent. In this regard, 14.8 g of PA (0.10 mol) is dissolved in 100 g of acetone at a temperature of about 50° C., and subsequently 47.5 g of ELO (0.05 mol) is added to this solution. The mixture was mixed at 50° C. for about 30 min to form prepolymer of ELO with PA. Viscosity of the prepolymer was adjusted by removing the excess of solvent, according to requirements of the dispensing equipment.

A binding adhesive composition is prepared using ELO as epoxy precursor, and PA as co-curing agent. In this regard, 14.8 g (0.10 mol) of PA is mixed with 47.5 g of ELO (0.05 mol) and the temperature of the mixture was increased to 180±5° C. under continuous mixing. After 6-8 min of prepolymerization, the prepolymer is chilled in an ice/water mixture to room temperature. The desired amount of solvent is added to dissolve the prepolymer to make it sprayable using dispensing equipment.

A binding composition is prepared using ECO and PA without a solvent. In this regard, 9.9-14.8 g (0.075-0.10 mol) of PA is mixed with 46.0 g of ECO (0.05 mol) and the temperature of the mixture was increased to 180±5° C. under continuous mixing. After 8-10 min of prepolymerization, the prepolymer is chilled in an ice/water mixture to room temperature. The desired amount of solvent is added to dissolve the prepolymer to make it sprayable using dispensing equipment.

A binding composition is prepared using ECO and TMA. In this regard, 12.8-19.2 g (0.075-0.10 mol) of TMA is dissolved (0.10 mol) is dissolved in 100 g of acetone at a temperature of about 50° C., and subsequently 46.0 g of ECO (0.05 mol) is added to this solution. The mixture was mixed at 50° C. for about 30 min to form a prepolymer of ECO with TMA. Viscosity of the prepolymer was adjusted by removing the excess of solvent, according to requirements of the dispensing equipment.

These exemplary binding compositions above demonstrates the possibilities of the biobased resins as a binding adhesive for lignocellulosic materials. However, it should be noted that all examples of bioresins disclosed within may be used as binding adhesives for binding of natural lignocellulosic fibers or organic fibers, forestry materials and wastes, glass and carbon fibers, to make composite materials.

### Example 15

### Biocomposite Preparation Having 100% Renewable Content

A binding adhesive composition of ELO with CA was prepared according to EXAMPLE 14. Fiber-mats made of flax and cedar fibers were preheated at about 100° C. in an oven prior to composite preparation. The binding composition in solvent was sprayed to the surface of the natural fiber-mats using a simple dispensing tool. Then, the wetted fiber-mat was sandwiched between rectangular brass molds, covered with thin aluminum foil, and placed between the preheated plates (170° C.) of a Carver Press. The composite was kept under a pressure of 1000-2000 PSI and cured at a temperature of 170° C. for 15 minutes. Then, the formed biocomposite was transferred to a preheated oven (170° C.) for post-curing duration from 4 up to 20 hrs. The final product is a biocomposite with about 70% of natural fibers (by weight), and consists of 100% renewable content.

Binding adhesives of ELO with TMA and ELO with PA have been prepared according to EXAMPLE 14, with a ratio of components 1.0:2.0 mol, respectively. Biocomposites were prepared using fiber-mats of flax, or flax and cedar mixtures, along with application of the prepared binding compositions, using the procedure described above. All composites were kept under pressure of 1000-2000 PSI and temperature of curing of 200° C. for up to 15 minutes. The final products are the biocomposites of natural fibers, with ≧90% renewable content, as flax derivatives.

Binding adhesives of ECO with PA are prepared according to the EXAMPLE 14, with the ratio of components of 1.0:1.5 and 1.0:2.0 mol. The viscosity of the prepolymer was adjusted with solvent according to the requirements of the dispensing tool. Biocomposites were prepared using fiber-mats of flax, flax and cedar mixtures, hemp, hemp and triticale mixtures, straw, sawdust, cedar chips, soybean protein fiber (SPF), using the procedure described above. The composite was kept under pressure of 1000-2000 PSI and temperature of curing of 200° C. for up to 15 minutes. The final product is a biocomposite of natural fibers, with ≧90% renewable content.

Binding adhesives of ECO with TMA and ELO with PA have been prepared according to EXAMPLE 14, with a ratio of components 1.0:1.5 and 1.0:2.0 mol. Biocomposites were prepared using lignocellulosic fibers or fiber-mats of flax, flax and cedar mixtures, hemp, hemp and triticale mixtures, straw, sawdust, cedar chips, SPF, using the procedure described above. All composites were kept under pressure of 1000-2000 PSI and temperature of curing of 200° C. for up to 15 minutes. The final products are the biocomposites of natural fibers, with ≧90% renewable content, as flax derivatives.

Binding adhesives of ECO with TMA has been prepared according to EXAMPLE 14, with a ratio of components 1.0:2.0 mol. Composites were prepared using glass-fibers using the procedure described above. All composites were kept under pressure of 1000-2000 PSI and temperature of curing of 200° C. for up to 15 minutes. The final product is a composite with ≧70% of glass fibers (by weight).

The lignocellulosic fibers with sprayed prepolymer of bioresins were stable (no curing was occurring) at room temperature even after three, weeks of storage; and molded biocomposites from these stored products had similar curing behaviour as an initial molded/cured composites, with no storage.

1. A method for preparing a thermoset resin prepolymer comprising the step of reacting an epoxidized oil derived from an unsaturated oil with a crosslinking carboxylic acid or an anhydride to prepare a prepolymer.

2. The method of claim 1 comprising the further step of molding and curing the prepolymers at elevated temperatures to make neat thermoset resins.

3. The method of claim 1 comprising the further step of mixing the prepolymer with reinforcing fibers and curing the material to form a thermoset composite material.

4. The method of claim 3 wherein some or all of the epoxidized oil, or the carboxylic acid, or the reinforcing fibers, are derived from renewable sources.

5. The method of claim 4 wherein the carboxylic acid comprises a natural food acid.

6. The method of claim 1 wherein the carboxylic acid comprises citric, malic, tartaric, oxalic, malonic, succinic, glutaric, adipic, pimelic, suberic, azelaic, sebacic, or lactic acid, or mixtures thereof.

7. The method of claim 1 wherein the crosslinking anhydride comprises aliphatic and aromatic anhydride or acid anhydride.

8. The method of claim 7 wherein the crosslinking anhydride comprises maleic, phthalic, trimellitic, pyromellitic, isophthalic, tetraphthtalic or succinic anhydrides, or mixtures thereof.

9. The method of claim 4 wherein the epoxidized oil is derived from an oil or fat comprising esterified unsaturated fatty acids.

10. The method of claim 9 wherein the epoxidized oil is derived from unsaturated oil comprising acylglycerides comprising monounsaturated or polyunsaturated fatty acids.

11. The method of claim 9 wherein the epoxidized oil is derived from alkyl esters of unsaturated fatty acids.

12. The method of claim 10 wherein the epoxidized oil is derived from linseed, canola, soybean, or camelina oil.

13. A thermoset resin prepolymer comprising an epoxidized oil derived from an unsaturated oil, mixed with a crosslinking carboxylic acid or a crosslinking anhydride.

14. The prepolymer of claim 13 wherein the epoxidized oil and the carboxylic acid are derived from renewable sources.

15. The prepolymer of claim 10 wherein the carboxylic acid comprises a natural food acid.

16. The prepolymer of claim 15 wherein the carboxylic acid comprises citric, malic, tartaric, acetic, oxalic, tannic, caffeotannic, benzoic, butyric, or lactic acid.

17. The prepolymer of claim 13 wherein the epoxidized oil is derived from vegetable oil comprising acylglycerols comprising mono- or polyunsaturated fatty acids.

18. The prepolymer of claim 17 wherein the epoxidized oil is derived from linseed, canola, soybean, or camelina oil.

19. A thermoset polymer comprising a cured prepolymer as claimed in claim 13.

20. A biocomposite material comprising a cured prepolymer as claimed in claim 13 and a reinforcing fiber.

21. (canceled)
